(19) United States
(12) Patent Application Publication
(10) Pub. No.: US 2006/0253682 A1
(43) Pub. Date: Nov. 9, 2006

(54) Managing computer memory in a computing environment with dynamic logical partitioning

(75) Inventors: William Joseph Armstrong, Rochester, MN (US); Richard Louis Arndt, Austin, TX (US); Michael Joseph Corrigan, Rochester, MN (US); David Robert Engebretsen, Cannon Falls, MN (US); Timothy Richard Marchini, Hyde Park, NY (US); Naresh Nayar, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/122,801

(22) Filed: May 5, 2005

(51) Int. Cl. G06F 12/00

(52) U.S. Cl. 711/173

(57) ABSTRACT

Managing computer memory in a computer with dynamic logical partitioning that operates transparently with respect to operating systems in logical partitions. Exemplary methods, systems, and products are described for managing computer memory in a computer with dynamic logical partitioning that include copying by a hypervisor, from page frames in one logical memory block (“LMB”) of a logical partition (“LPAR”) to page frames outside the LMB, contents of page frames having page frame numbers in a page table for an operating system in the LPAR. Embodiments typically include storing new page frame numbers in the page table, including storing by the hypervisor, for each page frame whose contents are copied, a new page frame number that identifies the page frame to which contents are copied. In typical embodiments, copying contents of page frames and storing new page frame numbers are carried out transparently with respect to the operating system.

### BACKGROUND OF THE INVENTION

1. Field of the Invention

The field of the invention is data processing, or, more specifically, methods, systems, and products for managing computer memory in a computer with dynamic logical partitioning.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Today there is a tendency to develop systems that are increasingly large in terms of the number of processors, number of input/output (“I/O”) slots, and memory size. Although advances in the design of computer hardware continue to provide rapid increases in the sizes of these physical resources, some major applications and subsystems lag behind in scalability. There is a trend therefore to provide systems with partitioning, physical partitions or logical partitions, so that the underlying computer system itself provides granularity of function. Physical partitions provide granularity of partitioning that is typically relatively coarse, because the partitioning occurs at physical boundaries such as multi-chip modules (“MCMs”), backplanes, daughter boards, mother boards, or other system boards. In a logically partitioned system, the granularity of partitioning is typically much more fine-grained, such as a single CPU or even a fraction of a CPU, a small block of memory, or an I/O slot instead of an entire I/O bus. With logical partitioning, a given set of computer resources can be subdivided into many more logical partitions than physical partitions.

A logical partition LPAR (“LPAR”) is a subset of computer resources that can host an instance of an operating system (“O/S”). LPARs are implemented through special hardware registers and a trusted firmware component called a hypervisor. Together, these components build a tight architectural ‘box’ around each logical partition, confining partition operations to an exclusive set of processor, memory, and I/O resources assigned to that partition. Today, as computer systems become larger and larger, the ability to run several instances of operating systems on a given hardware system, so that each O/S instance plus its subsystems scale or perform well, support optimum use of the hardware and translates into cost saving. Although static partitioning helps to tune overall system performance, logically partitioned systems today also may provide ‘dynamic reconfiguration’ capabilities, enabling the movement of hardware resources, processors, memory, I/O slots, and so on, to or from an LPAR or from one LPAR to another, without requiring reboots. Dynamic reconfiguration enables an improved solution by providing the capability to dynamically move hardware resources to a needy O/S in a timely fashion to match workload demands.

Typical dynamic reconfiguration tools today, however, rely upon cooperation or coordination between a hypervisor and an operating system in an LPAR, a pattern of computer operation that has some drawbacks. In dynamic reconfiguration of memory, for example, an O/S may hold bolted or pinned page frames, that the O/S will not release. Many different operating systems may run in separate LPARs at the same time on the same system. IBM's POWER™ hypervisor, for example, supports three different operating systems. One or more of the supported operating systems simply may not support the functions required for such cooperation with a hypervisor. In addition, in a cooperative scheme, management of memory becomes more complex in a cooperative scheme as an errant or malicious instance of an O/S, not only may not cooperate at all, but may actually act in a manner harmful to efficient computer resource management.

### SUMMARY OF THE INVENTION

Methods, systems, and products are provided for managing computer memory in a computer with dynamic logical partitioning that operate transparently with respect to operating systems in logical partitions. Exemplary methods, systems, and products are described for managing computer memory in a computer with dynamic logical partitioning that include copying by a hypervisor, from page frames in one logical memory block (“LMB”) of a logical partition (“LPAR”) to page frames outside the LMB, contents of page frames having page frame numbers in a page table for an operating system in the LPAR. Embodiments typically include storing new page frame numbers in the page table, including storing by the hypervisor, for each page frame whose contents are copied, a new page frame number that identifies the page frame to which contents are copied. In typical embodiments, copying contents of page frames and storing new page frame numbers are carried out transparently with respect to the operating system.

Typical embodiments also include creating by the hypervisor a list of all the page frames in the page table; monitoring by the hypervisor calls from the operating system to the hypervisor that add page frames to the page table while the hypervisor is copying contents of page frames and storing new page frame numbers; adding to the list page frames added to the page table; and where copying contents of page frames is carried out by copying contents of page frames on the list.

In some embodiments, memory pages of more than one size are mapped to page frames of an LMB. Such embodiments typically include vectoring memory management interrupts from the operating system to the hypervisor and switching memory management operations for the operating system from the page table for the operating system to a temporary alternative page table. In such embodiments, copying contents of page frames typically is carried out by copying contents of page frames in segments having the same size as the smallest of the pages mapped to page frames of the LMB. Copying contents of page frames in such embodiments may be carried out by deleting, from the temporary alternative page table, page frames that are also in the page table for the operating system and storing, in the page table for the operating system, the status bits of such deleted page frames.

In some embodiments, page frames of an LMB may be mapped for direct memory access (“DMA”). Copying contents of page frames in such embodiments may include blocking, by the hypervisor, DMA operations while copying contents of page frames mapped for DMA and storing, in a DMA map table for each page frame of the LMB mapped for DMA, a new page frame number that identifies the page frame to which contents are copied.

Embodiments may include creating a segment of free contiguous memory that is both larger than an LMB and also large enough to contain a page table. Creating a segment of free contiguous memory may be accomplished by carrying out the following steps repeatedly by the hypervisor for two or more contiguous LMBs: copying by the hypervisor, from page frames in the LMBs to page frames outside the LMBs, contents of page frames of the LMBs that are in a page table for an operating system in the LPAR; storing new page frame numbers in the page table, including storing by the hypervisor, for each page frame whose contents are copied, a new page frame number that identifies the page frame to which contents are copied; and adding the LMBs to a list of free memory for the system.

Embodiments may also include improving the affinity of an LMB to a processor. In such embodiments, copying contents of page frames of the LMB may include copying contents of page frames of the LMB to interim page frames outside the LMB, copying contents of page frames of a second LMB to the page frames of the LMB, and copying contents of the interim page frames to page frames of the second LMB. In such embodiments, storing new page frame numbers may include storing new page frame numbers that identify the page frames to which contents are copied both for contents of the LMB and for contents of the second LMB.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer for managing computer memory with dynamic logical partitioning according to embodiments of the present invention.

FIG. 2 sets forth a block diagram of a further exemplary computer for managing computer memory with dynamic logical partitioning according to embodiments of the present invention.

FIG. 3 sets forth a block diagram of a further exemplary computer system with dynamic logical partitioning that manages computer memory according to embodiments of the present invention.

FIG. 4 sets forth a flow chart illustrating an exemplary method for managing computer memory in a computer with dynamic logical partitioning according to embodiments of the present invention.

FIG. 5 sets forth a flow chart illustrating a further exemplary method for managing computer memory in a computer with dynamic logical partitioning.

FIG. 6 sets forth a flow chart illustrating a further exemplary method for managing computer memory in a computer with dynamic logical partitioning.

FIG. 7 sets forth a flow chart illustrating an exemplary method of creating a segment of free contiguous memory.

FIG. 8 sets forth a flow chart illustrating an exemplary method of improving the affinity of an LMB to a processor.

### DETAILED DESCRIPTION OF EXEMPLARY EMBODIMENTS

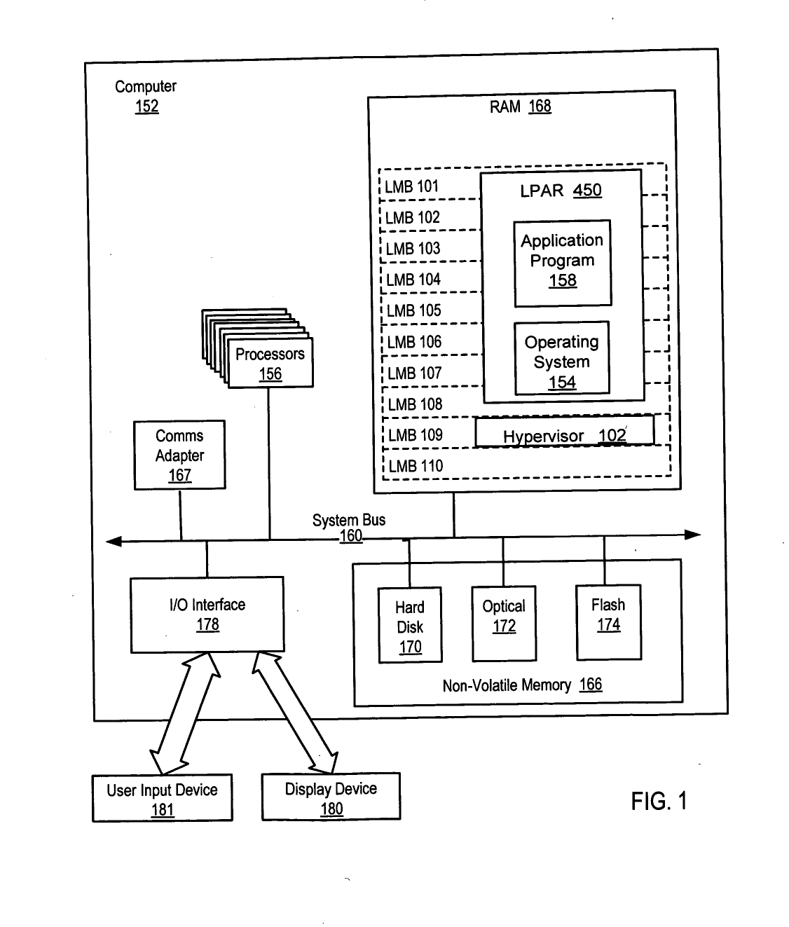

Exemplary methods, systems, and products for managing computer memory in a computer with dynamic logical partitioning according to embodiments of the present invention are described with reference to the accompanying drawings, beginning with FIG. 1. Managing computer memory in a computer with dynamic logical partitioning in accordance with the present invention is generally implemented with automated computing machinery, that is, with computers. For further explanation, therefore, FIG. 1 sets forth a block diagram of automated computing machinery comprising an exemplary computer (152) for managing computer memory with dynamic logical partitioning according to embodiments of the present invention. The computer (152) of FIG. 1 includes at least one computer processor (156) or ‘CPU’ as well as random access memory (168) (“RAM”) which is connected through a system bus (160) to processor (156) and to other components of the computer. As a practical matter, systems for managing computer memory in a computer with dynamic logical partitioning according to embodiments of the present invention typically include more than one computer processor. RAM (168) in the example of FIG. 1 is administered in segments called logical memory blocks or ‘LMBs’ (101-110).

Stored in RAM (168) is an application program (158), computer program instructions for user-level data processing implementing threads of execution. Also stored in RAM (168) is a hypervisor (102), a set of computer program instructions for managing resources in LPARs improved for managing computer memory in a computer with dynamic logical partitioning according to embodiments of the present invention. Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154) and application program (158) are disposed within an LPAR (450). Operating system (154), application program (158), and hypervisor (102) in the example of FIG. 1 are shown in RAM (168), but readers will understand that components of such software may be stored in non-volatile memory (166) also.

The system of FIG. 1 supports dynamic logical partitioning and may operate generally to manage computer memory by copying by hypervisor (102), from page frames in one logical memory block (“LMB”) of a logical partition (“LPAR”) to page frames outside the LMB, contents of page frames having page frame numbers in a page table for an operating system in the LPAR and storing new page frame numbers in the page table, including storing by the hypervisor, for each page frame whose contents are copied, a new page frame number that identifies the page frame to which contents are copied. In the system of FIG. 1, copying contents of page frames and storing new page frame numbers may be carried out transparently with respect to the operating system (154).

Computer (152) of FIG. 1 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 1 includes one or more I/O interface adapters (178). Input/output interface adapters in computers implement user-oriented input/output through, for example, software drivers and computer hardware for controlling output to display devices (180) such as computer display screens, as well as user input from user input devices (181) such as keyboards and mice. I/O hardware resources that implement I/O in conjunction I/O adapters are referred to generally in this specification as ‘I/O slots.’

The exemplary computer (152) of FIG. 1 includes a communications adapter (167) for implementing data communications. Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

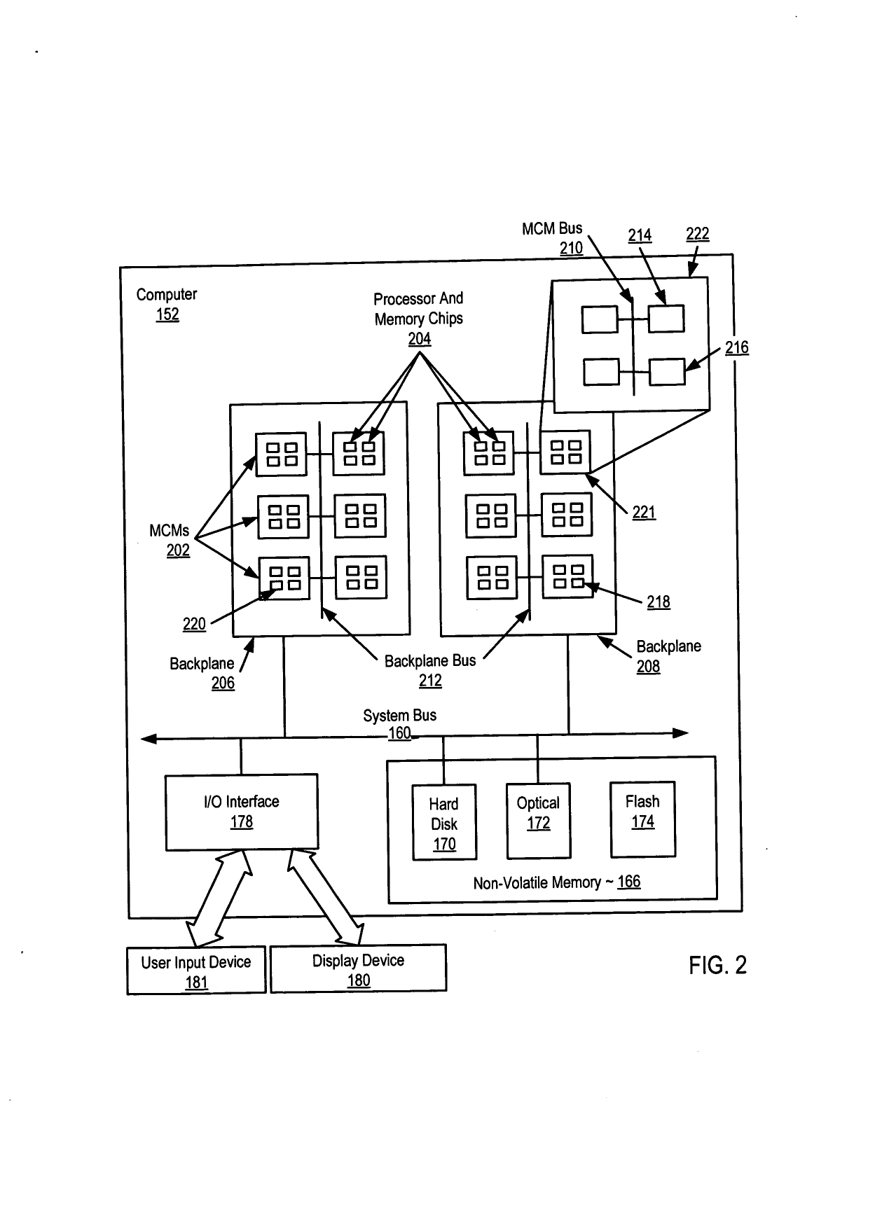

For further explanation, FIG. 2 sets forth a block diagram of a further exemplary computer (152) for managing computer memory with dynamic logical partitioning according to embodiments of the present invention. FIG. 2 is structured to further explain management of physical memory in systems for managing computer memory in a computer with dynamic logical partitioning according to embodiments of the present invention. Physical memory in the system of FIG. 2 is disposed along with processor chips in memory chips (204) in multi-chip modules (“MCMs”) (202). The MCMs in turn are implemented on backplanes (206, 208) which in turn are coupled for data communications through system bus (160). The MCMs on the backplanes are coupled for data communications through backplane buses (212), and the processor chips and memory chips on MCMs are coupled for data communications through MCM buses, illustrated at reference (210) on MCM (222), which expands the drawing representation of MCM (221).

A multi-chip module or ‘MCM’ is an electronic system or subsystem with two or more bare integrated circuits (bare dies) or ‘chip-sized packages’ assembled on a substrate. In the example of FIG. 2, the chips in the MCMs are computer processors and computer memory. The substrate may be a printed circuit board or a thick or thin film ceramic or silicon with an interconnection pattern, for example. The substrate may be an integral part of the MCM package or may be mounted within the MCM package. MCMs are useful in computer hardware architectures because they represent a packaging level between application-specific integrated circuits (‘ASICs’) and printed circuit boards.

The MCMs of FIG. 2 illustrate levels of hardware memory separation or ‘affinity.’ A processor (214) on MCM (222) may access physical memory:
in a memory chip (216) on the same MCM with the processor (214) accessing the memory chip,
in a memory chip (218) on another MCM on the same backplane (208), or
in a memory chip (220) in another MCM on another backplane (206).

Accessing memory off the MCM takes longer than accessing memory on the same MCM with the processor, because computer instructions for accessing such memory and return data from such memory must traverse more computer hardware, memory management units, bus drivers, not to mention the length of bus lands and wires which themselves are a consideration at today's computation speeds. Accessing memory off the same backplane takes even longer—for the same reasons. Memory on the same MCM with the processor accessing it therefore is said to have closer affinity than memory off the MCM, and memory on the same backplane with an accessing processor is said to have closer affinity than memory on another backplane. The computer architecture so described is for explanation, not for limitation of the computer memory. Several MCMs may be installed upon printed circuit boards, for example, with the printed circuit boards plugged into backplanes, thereby creating an additional level of affinity not illustrated in FIG. 2. Other aspects of computer architecture as will occur to those of skill in the art may affect processor-memory affinity, and all such aspects are within the scope of memory management with dynamic logical partitioning according to embodiments of the present invention.

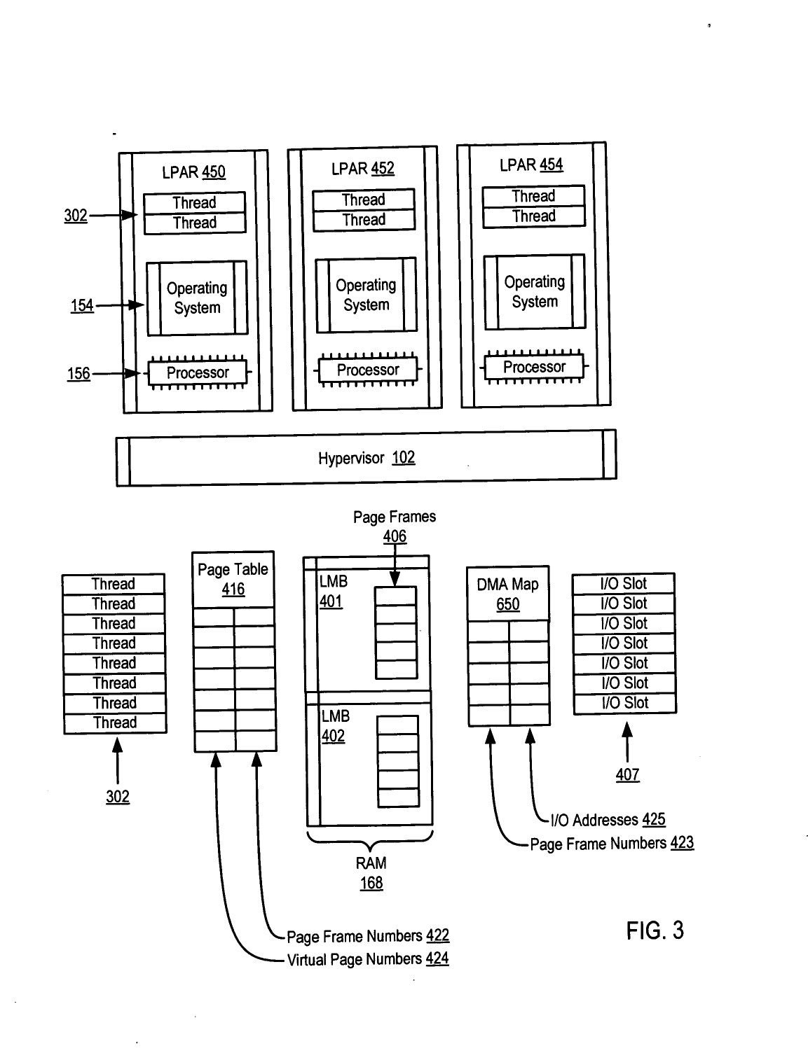

For further explanation, FIG. 3 sets forth a block diagram of a further exemplary computer system with dynamic logical partitioning that manages computer memory according to embodiments of the present invention. As mentioned above, logical partitioning is a computer design feature that provides flexibility by making it possible to run multiple, independent operating system images concurrently on a single computer.

The system of FIG. 3 includes a hypervisor (102) as well as three processors (156) and three operating systems (154) that can run multiple threads (302) of execution for application software in LPARs (450, 452, 454). The use of three examples is for explanation, not for limitation. In fact, persons of skill in the art will recognize that a system such as the one illustrated may operate any number of LPARs, operating systems, processors, and threads limited only by the actual quantity of physical resources in the system. The threads (302) operate on virtual memory addresses organized in a virtual address space. Processors (156) access physical memory organized in a real address space.

Each operating system image (154) requires a range of memory that can be accessed in real addressing mode. In this mode, no virtual address translation is performed, and addresses start at address 0. Operating systems typically use this address range for startup kernel code, fixed kernel structures, and interrupt vectors. Since multiple partitions can not be allowed to share the same memory range at physical address 0, each LPAR must have its own real mode addressing range.

The hypervisor assigns each LPAR a unique real mode address offset and range value, and then sets these offset and range values into registers in each processor in the partition. These values map to a physical memory address range that has been exclusively assigned to that partition. When partition programs access instructions and data in real addressing mode, the hardware automatically adds the real mode offset value to each address before accessing physical memory. In this way, each logical partition programming model appears to have access to physical address 0, even though addresses are being transparently redirected to another address range. Hardware logic prevents modification of these registers by operating system code running in the partitions. Any attempt to access a real address outside the assigned range results in an addressing exception interrupt, which is handled by the operating system exception handler in the partition.

Operating systems use another type of addressing, virtual addressing, to give user application threads an effective address space that exceeds the amount of physical memory installed in the system. The operating system does this by paging infrequently used programs and data from memory out to disk, and bringing them back into physical memory on demand.

When applications access instructions and data in virtual addressing mode, they are not aware that their addresses are being translated by virtual memory management using page translation tables (416). These tables, referred to generally in this specification as ‘page tables,’ reside in system memory, and each partition has its own exclusive page table administered on its behalf by the hypervisor. Processors use these tables (via calls to the hypervisor) to transparently convert a program's virtual address (424) into the physical address (422) where that page has been mapped into physical memory. If, when a thread accesses a page of memory, the page frame has been moved out of physical memory onto disk, the operating system receives a page fault.

In a non-LPAR operation, an operating system creates and maintains page table entries directly, using real mode addressing to access the tables. In a logical partitioning operation, the page translation tables are placed in reserved physical memory regions that are only accessible to the hypervisor. In other words, a partition's page table is located outside the partition's real mode address range. The register that provides a processor the physical address of its page table can only be modified by the hypervisor.

Virtual addresses are implemented as a combination of a virtual page number (424) and an offset within a virtual page. Real addresses are implemented as a combination of a page frame number (422) that identifies a page of real memory and an offset within that page. The offset for a virtual address is also the offset for the real address to which the virtual address is mapped. Page tables map virtual addresses to real addresses, but because the offsets are equal, the page tables map with only the virtual page numbers and the corresponding page frame numbers. The offsets are not included in the page tables.

When an operating system (154) needs to create a page translation mapping, it executes a call to the hypervisor (102) on a processor (156), which transfers execution to the hypervisor. The hypervisor creates the page table entry on the partition's behalf and stores it in the page table. Threads can also make hypervisor calls to modify or delete existing page table entries. Page table entries only map into specific physical memory regions, called logical memory blocks or ‘LMBs,’ which are assigned in granular segments to each LMB. These LMBs provide the physical memory that backs up the LPAR's virtual page address spaces. An LPAR's memory, therefore, is generally made up of LMBs which may be assigned in any order from anywhere in physical memory.

I/O hardware use direct memory access (‘DMA’) operations to move data between I/O adapters in I/O slots (407) and page frames (406) in system memory. DMA operations use an address relocation mechanism similar to page tables. I/O hardware translates addresses (425) generated by I/O devices in I/O slots into physical memory addresses. I/O hardware makes this translation with a DMA map (650), sometimes also called a translation control entry (‘TCE’) table, stored in physical memory. As with page tables, the DMA map resides in a physical address region of system memory that is inaccessible by partitions and only accessible by the hypervisor. By calling a hypervisor service, partition programs can create, modify, or delete DMA map entries for an I/O slot assigned to that partition. When the I/O hardware translates an I/O adapter DMA address into physical memory, the resulting address falls within the physical memory space assigned to that partition.

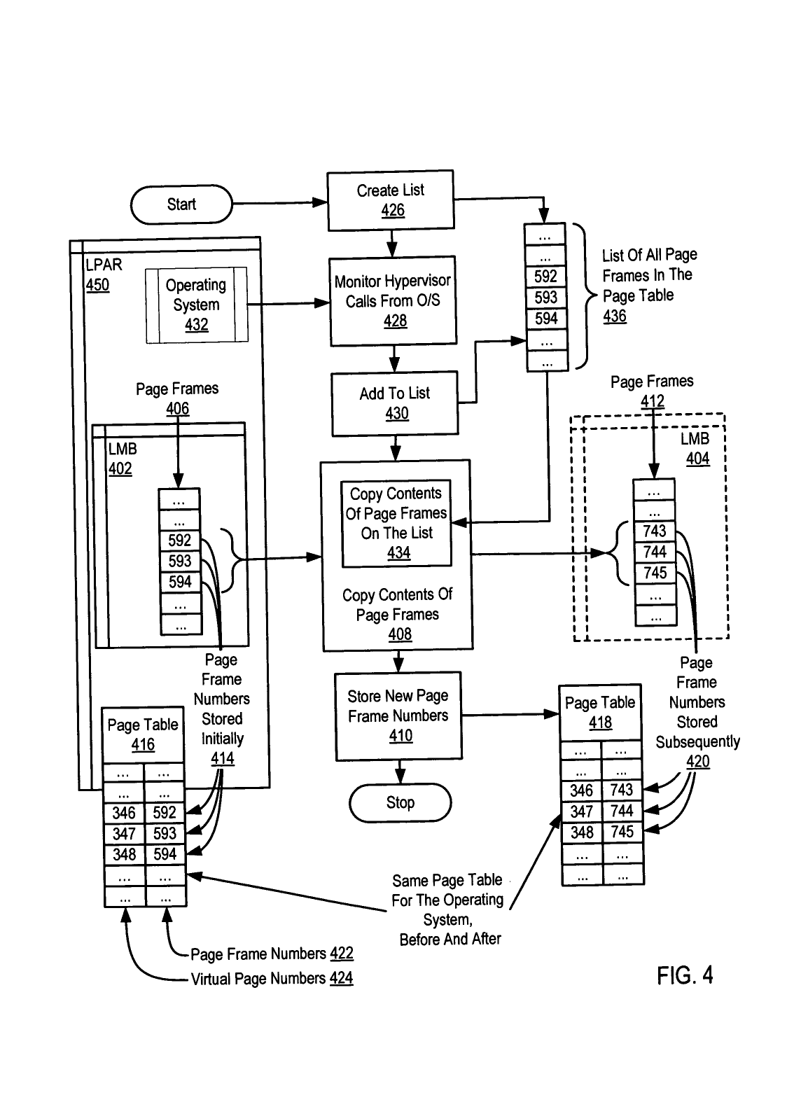

For further explanation, FIG. 4 sets forth a flow chart illustrating an exemplary method for managing computer memory in a computer with dynamic logical partitioning according to embodiments of the present invention that includes creating (426) by a hypervisor a list (436) of all the page frames in the page table. Carrying out memory management functions according to embodiments of the present invention advantageously are performed relatively quickly so as to reduce the risk of causing excessive memory faults and delay from the point of view of threads of execution in user applications. Scanning through page tables, which are large data structures, looking for mapped pages is time consuming. When conducting actual memory management operations, it is desirable to have a concise list of affected page frames stored in a quickly accessible structure. Such a list may be built by a hypervisor process running separately in background, for example, until the list is assembled. The method of FIG. 4 therefore advantageously includes monitoring (428) by the hypervisor calls from the operating system to the hypervisor that add page frames to the page table (416) while the hypervisor is copying contents of page frames and storing new page frame numbers. The method of FIG. 4 also includes adding (430) to the list (436) page frames added to the page table.

The method of FIG. 4 includes copying (408) by a hypervisor, from page frames (406) in one LMB (402) of an LPAR to page frames (412) outside the LMB (402), contents of page frames having page frame numbers (422) in a page table (416) for an operating system (432) in the LPAR (450). LMB (404) is shown in dotted outline to emphasize that, although all affected page frames are organized in LMBs, the locations of page frames (412) outside the LMB (402) that is the subject of memory management operations does not matter so long as they are not in subject LMB (402). In the method of FIG. 4, as mentioned above, copying (408) contents of page frames is carried out by copying (434) contents of page frames on the list (436). The method of FIG. 4 also includes storing (410) new page frame numbers in the page table (418), including storing by the hypervisor, for each page frame whose contents are copied, a new page frame number that identifies the page frame to which contents are copied.

The effect of these memory management operations is illustrated with page tables (416, 418). Page tables (416, 418) are the same page table illustrated before (416) and after (418) memory management operations in the method of FIG. 4. Before the memory management operations, the page table maps virtual page numbers 346, 347, and 348 to page frames 592, 593, and 594, which are disposed in LMB (402). After memory management operations in the example of FIG. 4, the page table maps virtual page numbers 346, 347, and 348 to page frames 592, 593, and 594, which are disposed outside LMB (402). Because the contents of page frames 592, 593, and 594 were copied, rather than moved, to page frames 743, 744, and 745, the contents of page frames 592, 593, and 594 are unaffected. The virtual pages that were previously mapped to them, however, are now mapped elsewhere to other page frames. This effectively frees the page frames of LMB (402) for other uses. They may be listed as free, used to install a large page table for a new LPAR, used to improve processor-memory affinity, or used otherwise as will occur to those of skill in the art.

In the method of FIG. 4, copying contents of page frames and storing new page frame numbers are carried out transparently with respect to the operating system. The next time the operating system experiences a memory fault in accessing one the remapped virtual pages, the contents of the physical memory at the new page frame in LMB (404) will be the same as they were before the memory management operations of the method of FIG. 4 were applied. In carrying out the method of FIG. 4, a hypervisor makes no calls to the operating system (432) requesting the release of resources, and the operating system is never aware that page table entries have been affected.

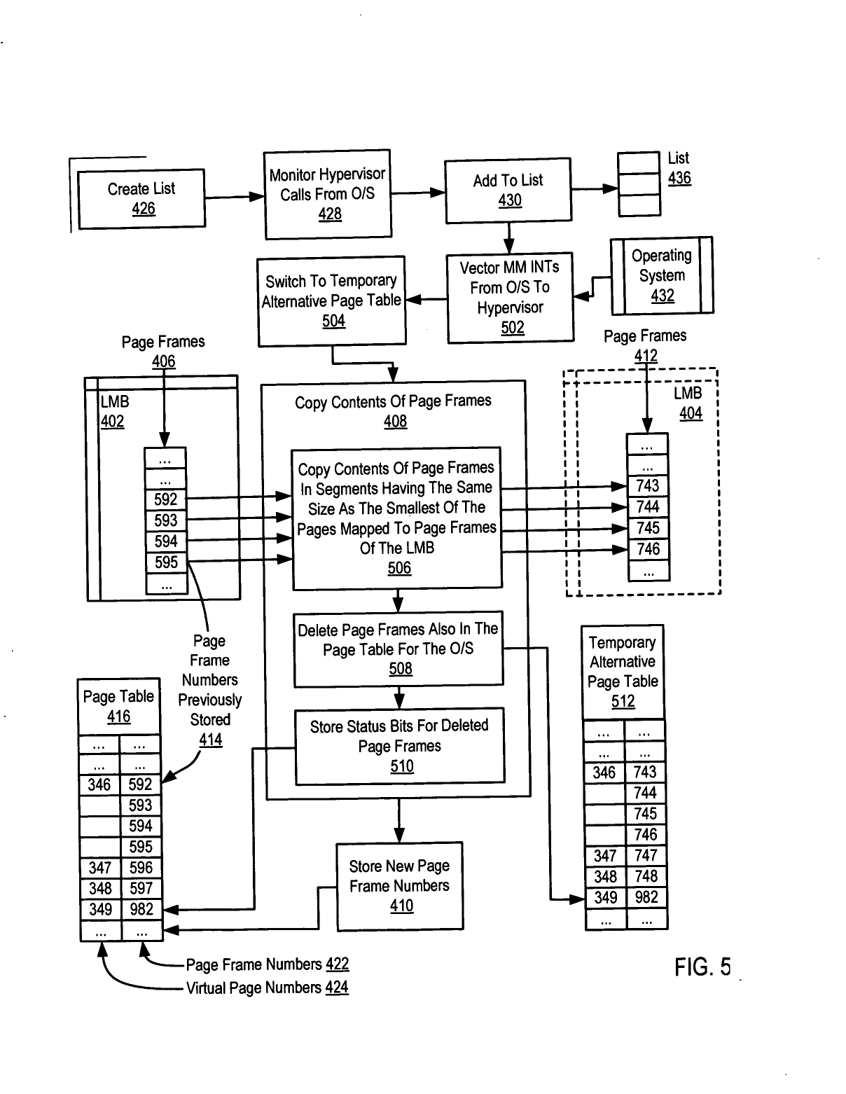

For further explanation, FIG. 5 sets forth a flow chart illustrating a further exemplary method for managing computer memory in a computer with dynamic logical partitioning according to embodiments of the present invention where memory pages of more than one size are mapped to the page frames (406) of an LMB (402). As mentioned above, LPARs may support more than one kind of operating system, each type of operating system may support a different page size, and each operating system may support more than one page size. Carrying out memory management functions according to embodiments of the present invention advantageously are performed relatively quickly so as to reduce the risk of causing excessive memory faults and delay from the point of view of threads of execution in user applications. Copying contents of small memory pages is faster than copying contents of large pages. The method of FIG. 5 therefore advantageously provides a way of carrying out memory copy operations using a small page size when a subject operating system uses more than one page size.

The method of FIG. 5 includes vectoring (502) memory management interrupts from the operating system (432) to the hypervisor. The hypervisor vectors memory management interrupts from the operating system to the hypervisor by setting a bit in a processor register so that the memory management interrupts are directed to the hypervisor interrupt vectors. This mechanism allows the hypervisor to block a processor in the hypervisor when a copy operation is in progress on the page frame. Since the interrupt is presented to the hypervisor using hypervisor register resources, the memory fault is transparent to the operating system.

In the example of FIG. 5, if the small page size is taken as 4 KB, then operating system (432) is shown using two page sizes, 4 KB and 16 KB. This is illustrated in page table (416) where a virtual page of 16 KB, virtual memory page 346, is mapped to four 4 KB pages frames, page frames 592, 593, 594, and 595. Other 4 KB virtual pages 347, 348, 349 map one-on-one to 4 KB page frames 596, 597, and 598 respectively. The method of FIG. 5 includes switching (504) memory management operations for the operating system from the page table (416) for the operating system to a temporary alternative page table (512) to support copy operations in 4 KB page frames only, ignoring any large page indications from the operating system present in page table (416). In the method of FIG. 5, copying (408) contents of page frames includes copying (506) contents of page frames in segments having the same size as the smallest of the pages mapped to page frames of the LMB. That is, the hypervisor carries out the copy operation in 4 KB segments only, 4 KB page frame by 4 KB page frame.

When a memory management interrupt occurs, the hypervisor looks up the real page table of the operating system to see whether the memory management interrupt would have occurred if the partition's real page table was in use. If so, the hypervisor gives control to the OS memory management interrupt vector. Otherwise, the page frame entry is inserted into the temporary alternative page table (if a copy operation is not in progress).

In the method of FIG. 5, copying (408) contents of page frames also includes deleting (508), from the temporary alternative page table (512), page frames that are also in the page table for the operating system. In the method of FIG. 5, copying (408) contents of page frames also includes storing (510), in the page table (416) for the operating system (432), the status bits of such deleted page frames. Status of such deleted page frames are indicated by reference bits (for LRU operations in memory faults) and by change bits (indicating that a page has been written to and must be saved back to disk when deleted from a cache).

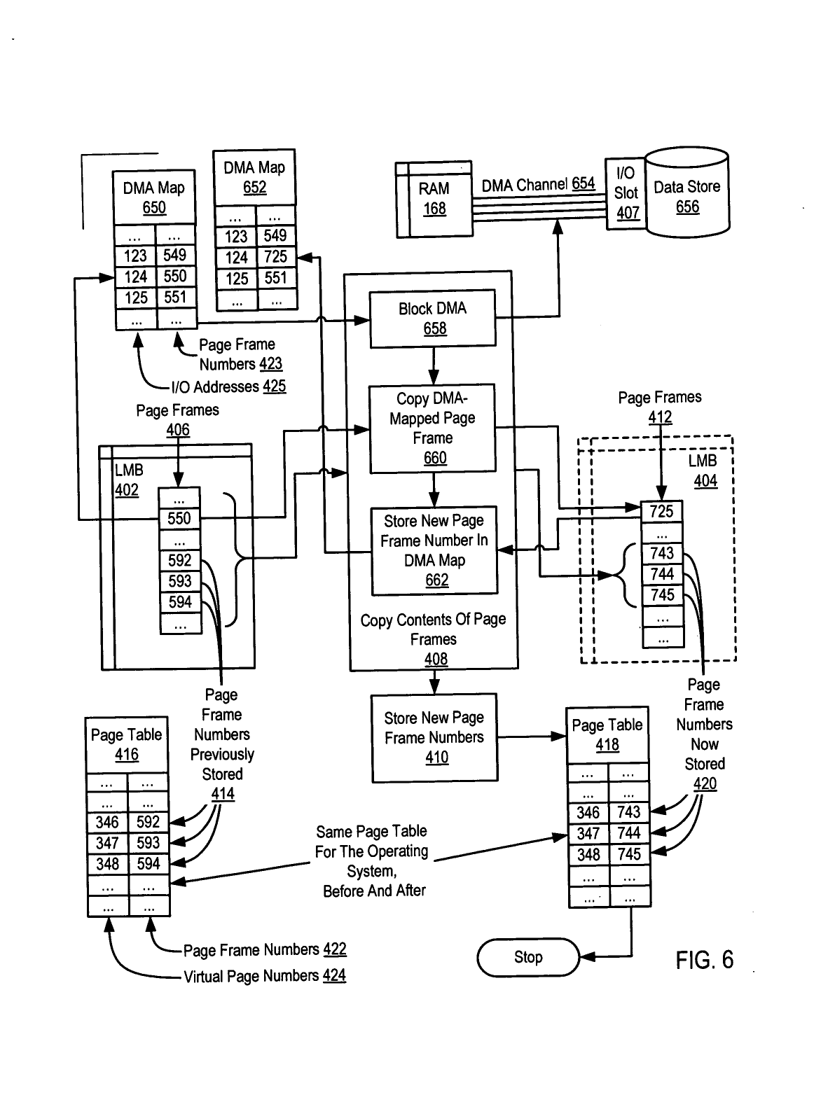

For further explanation, FIG. 6 sets forth a flow chart illustrating a further exemplary method for managing computer memory in a computer with dynamic logical partitioning according to embodiments of the present invention where at least one of the page frames (406) of the LMB (402) is mapped for direct memory access (“DMA”). In the method of FIG. 6, copying (408) contents of page frames includes blocking (658), by a hypervisor (not shown), DMA operations while copying (660) contents of page frames (423) mapped for DMA.

In the method of FIG. 6, DMA operations are represented by I/O slot (407) which contains an I/O adapter (not shown) that implements disk I/O on behalf of data store (656) through DMA channel (654) through page frames in system RAM (168). Page frames in system RAM are mapped to I/O addresses through DMA map (650). In the method of FIG. 6, copying (408) contents of page frames includes copying (660) the DMA-mapped page frame 550 to page frames (412) outside of LMB (402) and storing (662), in a DMA map table (652) for each page frame of the LMB mapped for DMA, a new page frame number that identifies the page frame to which contents are copied.

DMA maps (650, 652) illustrate the effects of memory management operations according to the method of FIG. 6. DMA maps are data structures, sometimes called translation entry tables or ‘TCE tables,’ each entry in which maps an address in an I/O address space to a page frame in system physical memory. Addresses in I/O address space may be an address in the address space of an I/O adapter or a PCI (Peripheral Component Interconnect) bus adapter, for example. In FIG. 6, DMA maps (650, 652) are the same DMA map before (650) and after (652) memory management operations according to the method of FIG. 6 respectively. In the example of FIG. 6, I/O address (425) 124 is initially mapped to page frame 550. After blocking DMA operations for the page, copying the DMA mapped page frame, and storing a new page frame number in the map according to the method of FIG. 6, DMA map (652) shows I/O address 124 mapped to page frame 725. This effectively frees page frame 550 of LMB (402) for other uses. It may be listed as free, used with other page frames or other LMBs to install a large page table for a new LPAR, used to improve processor-memory affinity, or used otherwise as will occur to those of skill in the art.

Page tables typically are large data structures, often substantially larger than an LMB. When a system administrator tries to create a new LPAR dynamically (without a reboot) there may not be enough contiguous memory available for the page table for the new LPAR. Managing computer memory in a computer with dynamic logical partitioning according to embodiments of the present invention advantageously therefore may include creating a segment of free contiguous memory that is both larger than an LMB and also large enough to contain a page table.

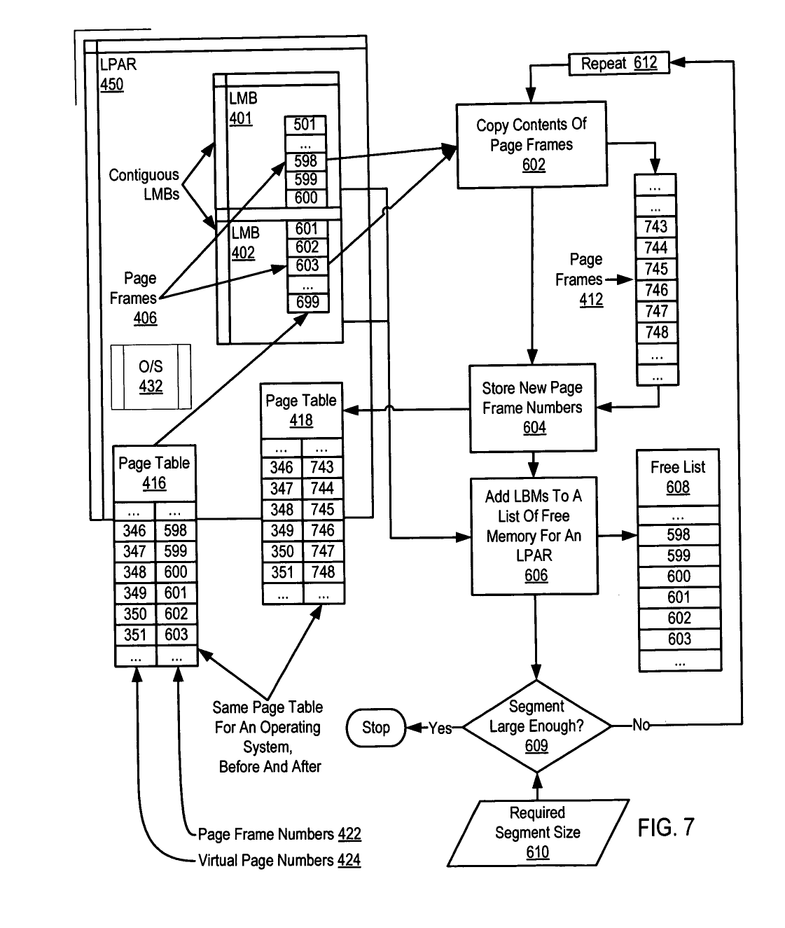

For further explanation, FIG. 7 sets forth a flow chart illustrating an exemplary method of creating a segment of free contiguous memory that includes copying (602) by a hypervisor, from page frames (406) in contiguous LMBs (401, 402) to page frames (412) outside the contiguous LMBs, contents of page frames of the contiguous LMBs that are in a page table (416) for an operating system (432) in the LPAR (450). The method of FIG. 7 includes storing (604) new page frame numbers in the page table (418), including storing by the hypervisor, for each page frame whose contents are copied, a new page frame number that identifies the page frame to which contents are copied.

The method of FIG. 7 also includes adding (606) the LMBs to a list (608) of free memory for the LPAR (450). In the example of FIG. 7, adding (606) the LMBs to a list (608) of free memory for the LPAR is carried out by placing the page frame numbers of freed page frames in a free list (608). Alternatively, the page frame number of the first page frame in an LMBs may be listed in a free list to indicate that the entire LMB is free. Other ways to indicate freed memory may occur to those of skill in the art, and all such ways are well within the scope of the present invention.

Often more than two contiguous LMBs must be freed to make room for a page table. The method of FIG. 7 therefore advantageously includes determining (609), with reference to a predetermined required segment size (610), whether a freed segment of memory is large enough to store a page table or meet other requirements for free memory. If the freed segment is not large enough, processing continues by repeating (612), until the freed segment is large enough, the steps of copying (602) contents of page frames of contiguous LMBs to page frames (412) outside the contiguous LMBs, storing (604) new page frame numbers in the page table (418), and adding (606) the LMBs to a list (608) of free memory for the LPAR.

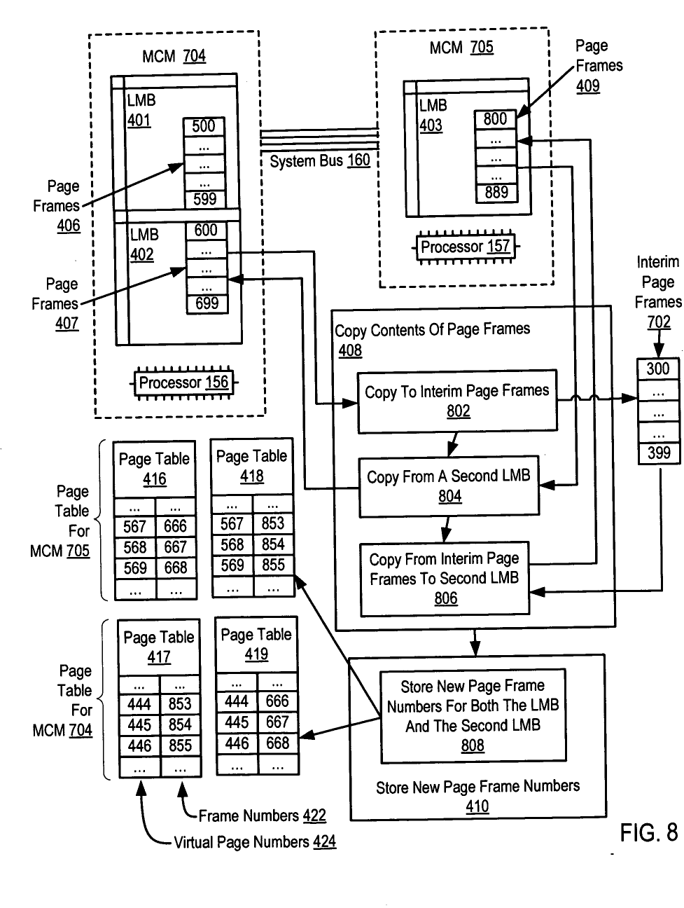

As affinity of accessed memory decreases with respect to an accessing processor, overall system performance degrades. Managing computer memory in a computer with dynamic logical partitioning according to embodiments of the present invention advantageously therefore may include improving the affinity of an LMB to a processor. For further explanation, FIG. 8 sets forth a flow chart illustrating an exemplary method of improving the affinity of an LMB to a processor. The method of FIG. 8 affects processor-memory affinity for two LMBs (402, 403). LMBs (402, 403) are located remotely from one another, LMB (402) in MCM 704 and LMB (403) in MCM (705). As described above, each MCM contains processors and memory. The method of FIG. 8 is carried out within a hypervisor. Processors and memory from each MCM is assigned by a hypervisor to an operating system in an LPAR (not shown on FIG. 8).

In the example of FIG. 8, processor (156) has close affinity with LMB (402) on the same MCM (704)—and lesser affinity with LMB (403) which is located remotely with respect to processor (156) on a separate MCM (705). Similarly in the example of FIG. 8, processor (157) has close affinity with LMB (403) on the same MCM (705)—and lesser affinity with LMB (402) which is located remotely with respect to processor (157) on a separate MCM (704). LMB (402) contains page frames numbered 600-699, and LMB (403) contains page frames 800-899. The page frame assignments in the LMBs are for explanation only, not for limitation. Readers will recognize that as a practical matter LMBs contain many more than 100 page frames. MCM (705) and MCM (704) are shown coupled through system bus (160), but readers will recognize that this architecture is for explanation of affinity only, not a limitation of the invention. In fact, remote affinity may be implemented through separate printed circuit boards, connections, through backplane or daughterboards, and otherwise as will occur to those of skill in the art.

Page table entries for two partitions on MCMs (704, 705) respectively are illustrated in page tables (416, 418, 417, and 419). Page tables (416, 418) show page table entries for MCM (705) before (416) and after (418) affinity improvement operations respectively. Similarly, page tables (417, 419) show page table entries for MCM (704) before (417) and after (419) affinity improvement operations respectively. Page table (416) shows that virtual page numbers 567, 568, and 569, in use by threads running on processor (157) on MCM (705), are mapped to page frames 666, 667, and 668, which are physically located in LMB (402) on MCM (704) having remote affinity with respect to processor (157). Similarly, page table (417) shows that virtual page numbers 444, 445, and 446, in use by threads running on processor (156) on MCM (704), are mapped to page frames 853, 854, and 855, which are physically located in LMB (403) on MCM (705) having remote affinity with respect to processor (156). Overall processor-memory affinity and memory management efficiency could be improved, for example, if pages frames mapped to virtual pages in use on the processors could be located or moved to physical memory on the same MCM with the processor. In addition, an LPAR may be implemented with processors on multiple MCMs, and such an LPAR may have multiple page tables also, for example, one for each MCM. Improving the affinity of an LMB to a processor according to embodiments of the present invention is useful also for such an LPAR with multiple page tables and processors on multiple MCMs.

The method of FIG. 8 includes copying contents of page frames (408), a process the operates basically as described above in this specification. For improving affinity, however, in the method of FIG. 8, copying (408) contents of page frames of the LMB advantageously includes copying (802) contents of page frames (406) of LMB (402) to interim page frames (702) outside LMB (402). Then copying (408) contents of page frames in the method of FIG. 8 also includes copying (804) contents of page frames (409) of LMB (403) to the page frames (406) of LMB (402) and copying (806) contents of the interim page frames (702) to page frames (409) of LMB (705). The method of FIG. 8 also includes storing (410) new page frame numbers, which operates generally as described above, but including here storing (808) new page frame numbers that identify the page frames to which contents are copied both for contents of the LMB (402) and for contents (409) of the second LMB (403).

Page tables (418, 419) show the effects of these affinity improvement operations. Page table (418) shows that virtual page numbers 567, 568, and 569, in use by threads running on processor (157) on MCM (705), are now mapped to page frames 853, 854, and 855, which are physically located in LMB (403) on MCM (705), now having close affinity with respect to processor (157) on the same MCM. Similarly, page table (419) shows that virtual page numbers 444,445, and 446, in use by threads running on processor (156) on MCM (704), are now mapped to page frames 666, 667, and 668, which are physically located in LMB (402) on MCM (704) having close affinity with respect to processor (156) on the same MCM.

Exemplary embodiments of the present invention are described largely in the context of a fully functional computer system for managing computer memory in a computer with dynamic logical partitioning. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for managing computer memory in a computer with dynamic logical partitioning, the method comprising:
copying by a hypervisor, from page frames in one logical memory block (“LMB”) of a logical partition (“LPAR”) to page frames outside the LMB, contents of page frames having page frame numbers in a page table for an operating system in the LPAR; and
storing new page frame numbers in the page table, including storing by the hypervisor, for each page frame whose contents are copied, a new page frame number that identifies the page frame to which contents are copied;
wherein copying contents of page frames and storing new page frame numbers are carried out transparently with respect to the operating system.

2. The method of claim 1 further comprising:
creating by the hypervisor a list of all the page frames in the page table;
monitoring by the hypervisor calls from the operating system to the hypervisor that add page frames to the page table while the hypervisor is copying contents of page frames and storing new page frame numbers; and
adding to the list page frames added to the page table;
wherein copying contents of page frames further comprises copying contents of page frames on the list.

3. The method of claim 1 wherein memory pages of more than one size are mapped to the page frames of the LMB, the method further comprising:
vectoring memory management interrupts from the operating system to the hypervisor; and
switching memory management operations for the operating system from the page table for the operating system to a temporary alternative page table;
wherein copying contents of page frames further comprises copying contents of page frames in segments having the same size as the smallest of the pages mapped to page frames of the LMB.

4. The method of claim 3 wherein copying contents of page frames further comprises:
deleting, from the temporary alternative page table, page frames that are also in the page table for the operating system; and
storing, in the page table for the operating system, the status bits of such deleted page frames.

5. The method of claim 1 wherein at least one of the page frames of the LMB is mapped for direct memory access (“DMA”) and copying contents of page frames further comprises:
blocking, by the hypervisor, DMA operations while copying contents of page frames mapped for DMA; and
storing, in a DMA map table for each page frame of the LMB mapped for DMA, a new page frame number that identifies the page frame to which contents are copied.

6. The method of claim 1 further comprising creating a segment of free contiguous memory that is both larger than an LMB and also large enough to contain a page table.

7. The method of claim 6 wherein creating a segment of free contiguous memory further comprises carrying out the following steps repeatedly by the hypervisor for two or more contiguous LMBs:
copying by the hypervisor, from page frames in the LMBs to page frames outside the LMBs, contents of page frames of the LMBs that are in a page table for an operating system in the LPAR;
storing new page frame numbers in the page table, including storing by the hypervisor, for each page frame whose contents are copied, a new page frame number that identifies the page frame to which contents are copied; and
adding the LMBs to a list of free memory.

8. The method of claim 1 further comprising improving the affinity of an LMB to a processor, wherein:
copying contents of page frames of the LMB further comprises:
copying contents of page frames of the LMB to interim page frames outside the LMB;
copying contents of page frames of a second LMB to the page frames of the LMB; and
copying contents of the interim page frames to page frames of the second LMB; and
storing new page frame numbers further comprises storing new page frame numbers that identifies the page frames to which contents are copied both for contents of the LMB and for contents of the second LMB.

9. An apparatus for managing computer memory in a computer with dynamic logical partitioning, the apparatus comprising a computer processor and a computer memory operatively coupled to the computer processor, the computer memory having disposed within it computer program instructions capable of:
copying by a hypervisor, from page frames in one logical memory block (“LMB”) of a logical partition (“LPAR”) to page frames outside the LMB, contents of page frames having page frame numbers in a page table for an operating system in the LPAR; and
storing new page frame numbers in the page table, including storing by the hypervisor, for each page frame whose contents are copied, a new page frame number that identifies the page frame to which contents are copied;
wherein the computer program instructions are further capable of copying contents of page frames and storing new page frame numbers transparently with respect to the operating system.

10. The apparatus of claim 9 further comprising computer program instructions capable of:
creating by the hypervisor a list of all the page frames in the page table;
monitoring by the hypervisor calls from the operating system to the hypervisor that add page frames to the page table while the hypervisor is copying contents of page frames and storing new page frame numbers; and
adding to the list page frames added to the page table;
wherein copying contents of page frames further comprises copying contents of page frames on the list.

11. The apparatus of claim 9 wherein memory pages of more than one size are mapped to the page frames of the LMB, the apparatus further comprising computer program instructions capable of:
vectoring memory management interrupts from the operating system to the hypervisor; and
switching memory management operations for the operating system from the page table for the operating system to a temporary alternative page table;
wherein copying contents of page frames further comprises copying contents of page frames in segments having the same size as the smallest of the pages mapped to page frames of the LMB.

12. The apparatus of claim 11 wherein copying contents of page frames further comprises:
deleting, from the temporary alternative page table, page frames that are also in the page table for the operating system; and
storing, in the page table for the operating system, the status bits of such deleted page frames.

13. The apparatus of claim 9 wherein at least one of the page frames of the LMB is mapped for direct memory access (“DMA”) and copying contents of page frames further comprises:
blocking, by the hypervisor, DMA operations while copying contents of page frames mapped for DMA; and
storing, in a DMA map table for each page frame of the LMB mapped for DMA, a new page frame number that identifies the page frame to which contents are copied.

14. The apparatus of claim 9 further comprising computer program instructions capable of creating a segment of free contiguous memory that is both larger than an LMB and also large enough to contain a page table.

15. The apparatus of claim 14 wherein creating a segment of free contiguous memory further comprises carrying out the following steps repeatedly by the hypervisor for two or more contiguous LMBs:
copying by the hypervisor, from page frames in the LMBs to page frames outside the LMBs, contents of page frames of the LMBs that are in a page table for an operating system in the LPAR;
storing new page frame numbers in the page table, including storing by the hypervisor, for each page frame whose contents are copied, a new page frame number that identifies the page frame to which contents are copied; and
adding the LMBs to a list of free memory.

16. The apparatus of claim 9 further comprising computer program instructions capable of improving the affinity of an LMB to a processor, wherein:
copying contents of page frames of the LMB further comprises:
copying contents of page frames of the LMB to interim page frames outside the LMB;
copying contents of page frames of a second LMB to the page frames of the LMB; and
copying contents of the interim page frames to page frames of the second LMB; and
storing new page frame numbers further comprises storing new page frame numbers that identifies the page frames to which contents are copied both for contents of the LMB and for contents of the second LMB.

17. A computer program product for managing computer memory in a computer with dynamic logical partitioning, the computer program product disposed upon a signal bearing medium, the computer program product comprising computer program instructions capable of:
copying by a hypervisor, from page frames in one logical memory block (“LMB”) of a logical partition (“LPAR”) to page frames outside the LMB, contents of page frames having page frame numbers in a page table for an operating system in the LPAR; and
storing new page frame numbers in the page table, including storing by the hypervisor, for each page frame whose contents are copied, a new page frame number that identifies the page frame to which contents are copied;
wherein copying contents of page frames and storing new page frame numbers are carried out transparently with respect to the operating system.

18. The computer program product of claim 17 further comprising computer program instructions capable of:
creating by the hypervisor a list of all the page frames in the page table;
monitoring by the hypervisor calls from the operating system to the hypervisor that add page frames to the page table while the hypervisor is copying contents of page frames and storing new page frame numbers; and
adding to the list page frames added to the page table;
wherein copying contents of page frames further comprises copying contents of page frames on the list.

19. The computer program product of claim 17 wherein memory pages of more than one size are mapped to the page frames of the LMB, the computer program product further comprising computer program instructions capable of:
vectoring memory management interrupts from the operating system to the hypervisor; and
switching memory management operations for the operating system from the page table for the operating system to a temporary alternative page table;
wherein copying contents of page frames further comprises copying contents of page frames in segments having the same size as the smallest of the pages mapped to page frames of the LMB.

20. The computer program product of claim 19 wherein copying contents of page frames further comprises:
deleting, from the temporary alternative page table, page frames that are also in the page table for the operating system; and
storing, in the page table for the operating system, the status bits of such deleted page frames.

21. The computer program product of claim 17 wherein at least one of the page frames of the LMB is mapped for direct memory access (“DMA”) and copying contents of page frames further comprises:
blocking, by the hypervisor, DMA operations while copying contents of page frames mapped for DMA; and
storing, in a DMA map table for each page frame of the LMB mapped for DMA, a new page frame number that identifies the page frame to which contents are copied.

22. The computer program product of claim 17 further comprising computer program instructions capable of creating a segment of free contiguous memory that is both larger than an LMB and also large enough to contain a page table.

23. The computer program product of claim 22 wherein creating a segment of free contiguous memory further comprises carrying out the following steps repeatedly by the hypervisor for two or more contiguous LMBs:
copying by the hypervisor, from page frames in the LMBs to page frames outside the LMBs, contents of page frames of the LMBs that are in a page table for an operating system in the LPAR.
storing new page frame numbers in the page table, including storing by the hypervisor, for each page frame whose contents are copied, a new page frame number that identifies the page frame to which contents are copied; and
adding the LMBs to a list of free memory.

24. The computer program product of claim 17 further comprising computer program instructions capable of improving the affinity of an LMB to a processor, wherein:
copying contents of page frames of the LMB further comprises:
copying contents of page frames of the LMB to interim page frames outside the LMB;
copying contents of page frames of a second LMB to the page, frames of the LMB; and
copying contents of the interim page frames to page frames of the second LMB; and
storing new page frame numbers further comprises storing new page frame numbers that identifies the page frames to which contents are copied both for contents of the LMB and for contents of the second LMB.
